(19) United States
(12) Patent Application Publication
(10) Pub. No.: US 2021/0298273 A1
(43) Pub. Date: Sep. 30, 2021

(54) COMBINATION PECKING BLOCK PROVIDING BOTH SOCIAL AND NUTRITIONAL PECKING OPPORTUNITIES

(71) Applicant: Zinpro Corporation, Eden Prairie, MN (US)

(72) Inventors: Michael Lane Lott, Rockport, TX (US); Allen J. Couvillion, Rainsville, AL (US)

(21) Appl. No.: 16/835,503

(22) Filed: Mar. 31, 2020

(51) Int. Cl. A01K 39/01; A01K 45/00

(52) U.S. Cl. CPC A01K 39/01; A01K 45/00

(57) ABSTRACT

A combination beak grooming pecking block and nutritional/medicament block for chickens and turkeys which can be mounted from a suspension point to prevent perching and defecating on the block.

### FIELD OF THE INVENTION

The present invention relates to a new design of pecking block which simultaneously provides social pecking opportunities for beak grooming and nutritional/medicinal pecking opportunities all while minimizing aggressive behavior of confined poultry.

Confined poultry, both chickens and turkeys, often out of frustration engage in feather pecking and other aggressive behavior techniques. Such is of course undesirable as it can drastically effect yields and in exaggerated cases can include aggression to the point of cannibalism.

### BACKGROUND OF THE INVENTION

In the past, pecking blocks have been developed and sold to minimize undesirable aggressive behavior. Such blocks have included for example Peckstone™ from Vilofoss designed for beak conditioning and the like. Other examples include pecking stones for birds, see U.S. Pat. No. 3,293,039, and blocks that are used to sit on the floor, or to be nailed to the wall. Such flock blocks do not work well for a variety of reasons.

Amongst the reasons are that such blocks are typically flat surfaces and the birds may sit on them as they pick and defecate on them. This contaminates the blocks so that later using birds may become infected. Also, the birds may simply quit using the blocks altogether.

Typically, there are two different types of blocks commonly used, one is a pecking block which as its primary purpose grooming beaks so that the confined birds do not feather peck at each other. The thought being that this avoids the need for debeaking. These blocks are harder surface blocks. Other blocks used, such as the block of U.S. Pat. No. 3,293,039 provide nutritional supplementation. That is to say, they provide the animal with flecking stone or cake of beneficial ingredients that may be dislodged and eaten. Here again the same problem occurs with these blocks, i.e. newly arriving birds jump on them, eat, and consume them but also defecate on the blocks contaminating them for later arriving flock members.

A pecking block for grooming of beaks must be of just the right hardness so that the birds will have some success in the pecking at the same time dulling the sharp edges of their beaks. In this regard, ordinary cement blocks are too hard with the animals having little success at pecking. They eventually discard the block. At that point the poultry will no longer be attracted to the block and ignore it. Traditional cake blocks used for nutrition are insufficiently hard to provide beak grooming.

Both blocks in the forms presently sold and particularly in the manner they are used, have the problem of accumulated poultry droppings to the point where later using birds are confronted with the droppings of earlier used birds. This is often exacerbated with nutritional blocks where birds peck at the nutritional supplement that is not only dropped on the floor but often mixed with excrement which leads to increased incidents of blackhead infections.

In short, while such blocks initially counteract the abnormal behavior amongst poultry (chickens and turkeys), that results from frustration of confinement, it is also known that the chickens and turkeys quickly become bored with the blocks returning to their abnormal aggressive behaviors which affect life and quality of the poultry.

In summary there is a continuing need for a block which can both provide beak grooming and nutrition without also increasing the incidents of infections caused by poultry defecating on the blocks.

This invention has as its primary objective the fulfillment of this continuing need.

### SUMMARY OF THE INVENTION

A pecking block which provides both social pecking opportunities and nutritional and a medicinal and/or nutritional pecking opportunity. It has an exterior lightweight cement block portion and an interior core portion which may be nutritional and/or medicinal acting in a cake or flaking like manner, with the entire block being suspended, at a suspension point to provide exterior surfaces that are at an angle to substantially prevent birds from roosting on the block.

### BRIEF DESCRIPTION OF THE DRAWINGS

FIG. 1 is a perspective view of a first preferred embodiment of a rectangular lightweight cement pecking block with a nutritional core suspended from a suspension point to prevent birds from perching on it.

FIG. 2 is a cross-sectional view through the block of FIG. 1 along line 2-2 to illustrate its constructional features.

FIG. 3 is another example of a similar block as FIG. 1, but in a circular shape.

FIG. 4 is a similar block in triangular shape.

FIG. 5 shows a similar block in dome shape.

FIG. 6 shows a perspective view of the block of FIG. 1 suspended from a suspension point hangar with a floor litter cover in place under it.

### DETAILED DESCRIPTION OF THE PREFERRED EMBODIMENTS

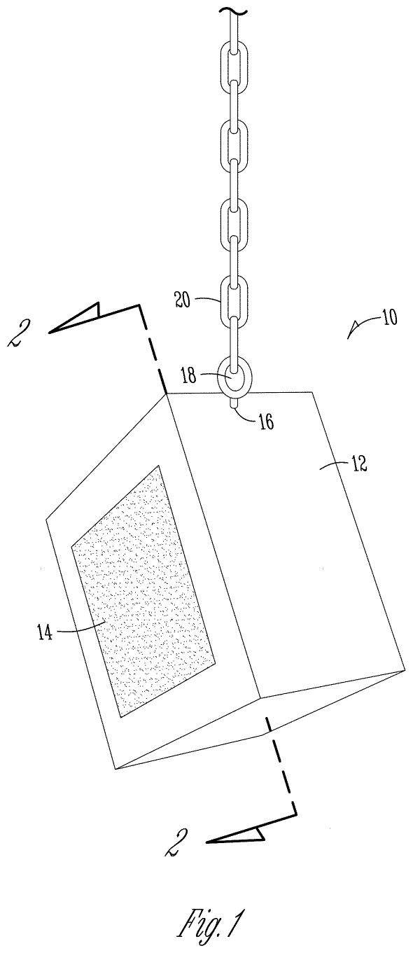

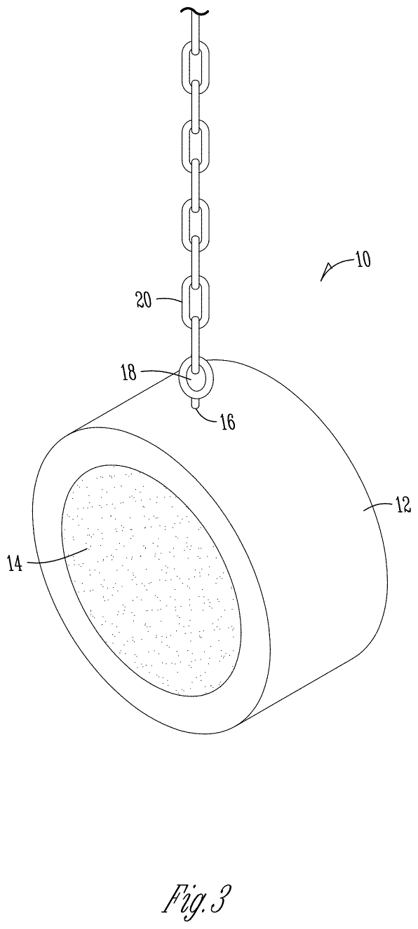

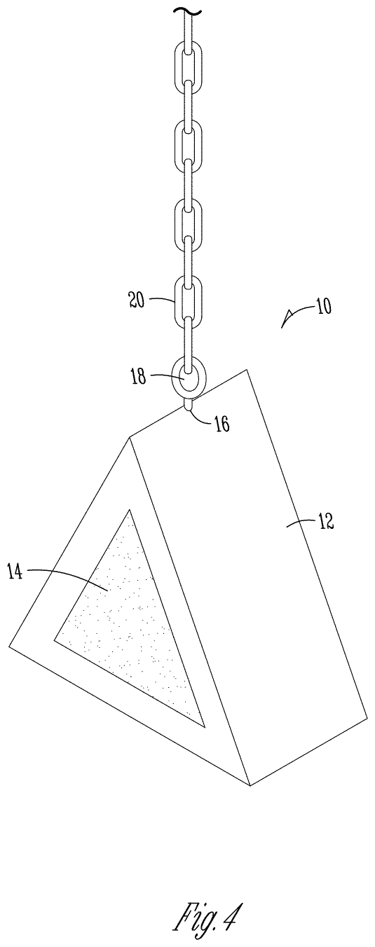

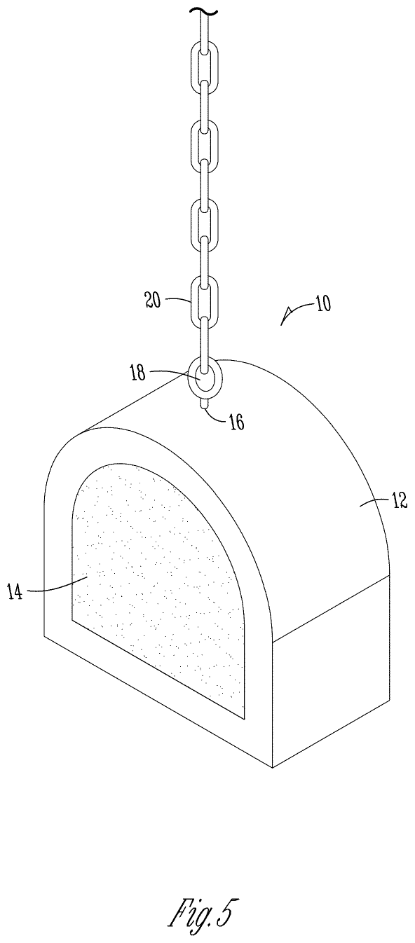

A pecking block 10 is generally to be understood to be composed of a material which encourages pecking, and which can be provided as a natural composite material, such as grit, or an artificially produced material in the form of a composite such as a lightweight cement. The pecking block 10 can come in a variety of different shapes including circular (FIG. 3), rectangular (FIG. 1), triangular (FIG. 4) or dome shape (FIG. 5). Preferred is rectangular as explained below.

Lightweight cement is known, and it is the preferred composite material for the block 10. Lightweight cement is generally made from clay, vermiculite and other porous materials that expand the volume of the cement mixture. It is simply poured into a mold and cured to provide the desired block shape, 10.

As previously explained, the cured pecking block 10 made of lightweight cement, as opposed to conventional masonry cement block formulations, is found to have the right hardness for beak manicure by natural pecking.

In making the overall combination pecking block 10 molded exterior portion 12 is filled with a nutritional or medicinal (or both) cake 14. The cake may be any suitable material of many that are known. It can follow many different formulations depending upon what nutritional or medicinal characteristics are desired. One suitable formulation is that shown U.S. Pat. No. 3,293,039, which is incorporated by reference.

Generally, any suitable lightweight cement may be used for block 12, as previously explained. It can consist of calcium, phosphorous, salt, magnesium, grit, Portland cement, limestone, vermiculite, binders, natural colors, flavors, essential oils and extracts.

The inner core 14 can act as a means of delivering various nutritional and/or medicinal components as the birds peck on it. The core may contain many AAFCO approved ingredients such as starch, corn syrup, molasses, feed grade binding agents, essential oils and extracts, seeds, probiotics, prebiotics, electrolytes, minerals, amino acids, insect growth regulators, vaccines, and other medications.

The inner core is frequently treated for gelatinization of starches and for adhesion and hardening. Heat pressing is commonly used to assure form fitting in the inner core 14 of block 12.

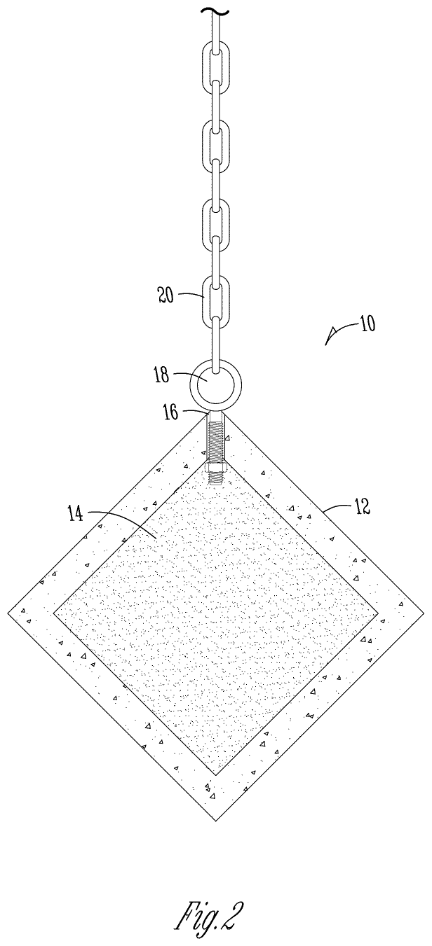

As illustrated in FIGS. 1-6, the block 10 may take a variety of shapes and has a point of suspension 16 where a hanger, for example any eyelet 18 suspends it by a rope or chain 20. As explained below the point of suspension is picked so that block 10 can be hung in a manner that prevents any flat surface for perching.

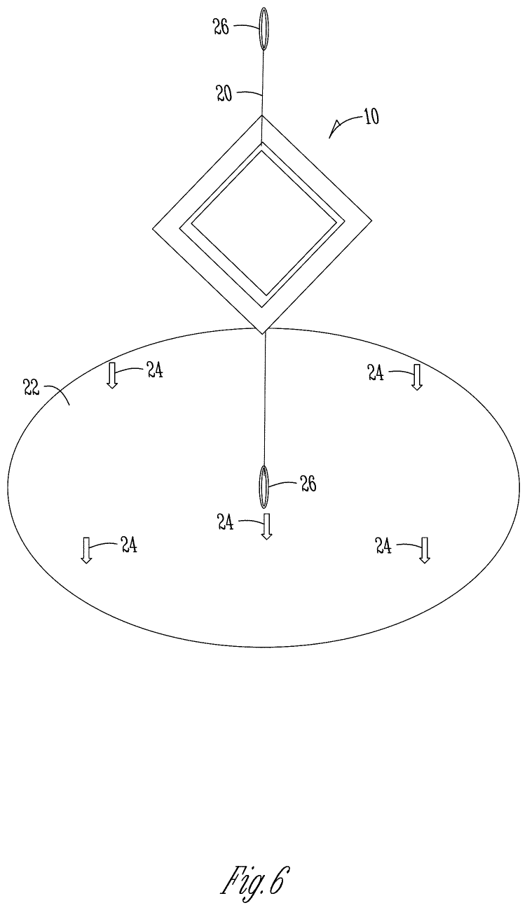

As illustrated in FIG. 6, the block 10 may include when sold a floor cover sheet 22 which can be attached to the floor with spikes 24. Also, the block 10 itself may be secured from above and below the point of suspension 16 at 26, for example for hanging from the ceiling and held tight at the floor to prevent swaying, as birds peck on it. The reason for the floor sheet 22 below the block is that birds will tend to pick the litter falling around the block to pick up the pieces of nutritional material. This also allows picking up of infections as the birds eat fecal worms and contaminated nutritional materials. Such can be avoided by simply picking up the floor cover and cleaning it from time to time.

The blocks 10 when suspended from the suspension point 16 prevent birds from landing on them and defecating on the block. That is the to say the block cannot be used for perching, further avoiding contamination issues. Ideally the exterior surface of the exterior lightweight cement block portion should be a downward angle of at least 35 degrees and preferably between 45 degrees and 80 degrees to prevent bird perching. Other features have been found desirable, for example blocks green in color are particularly preferred by the birds and will hold their attention much longer than blocks of other colors.

While any of the shapes herein mentioned may be utilized the preferred shape for the overall combination block is rectangular of FIG. 1 for ease of packaging and shelving and transportation.

An additional option suitable for any of the embodiments is an angled cone shape cover suspended above the block to offer further assurance of inability to perch on the pecking block or any portion of it including the cake portion 14. Looking for example the angled cone would be suspended on chain or rope 20 above the pecking block of whatever shape.

It can be seen that the above combination block allows self-grooming of beaks, and self-application of nutrition and medicaments while the birds are social pecking and prevents excrement adulteration of food and nutrition. It therefore accomplishes its primary objective.

What is claimed is:

1. A pecking block which provides both social pecking opportunities and nutritional/medicinal pecking opportunities comprising:
an exterior lightweight cement block portion having an exterior surface and a suspension point;
said exterior surface allowing arrangement at least in part to provide a surface inclined downwardly from said suspension point sufficiently to substantially prevent birds from roosting on it; and
having an interior core in said lightweight cement block portion to hold an inner core of nutritional/medicinal material which can be pecked and eaten away from said inner core.

2. The pecking block of claim 1 wherein the shape of the lightweight cement block portion is selected from the group of shapes consisting of rectangular blocks, triangular, circular blocks, cylindrical blocks, and dome shaped blocks.

3. The pecking block of claim 1 wherein the interior core material is a combination of both nutritional and medicinal material.

4. The pecking block of claim 1 wherein the angle from the said suspension point downward is at least 35°.

5. The pecking block of claim 4 wherein the angle from the suspension point downwardly of the surface of said block is within the range of about 35° to about 80°.

6. The pecking block of claim 1 wherein the lightweight cement block is comprised of materials selected from the group consisting of calcium, phosphorous, grit, salt, magnesium, Portland cement, limestone, vermiculite, binders, natural colors, flavors, and essential oils.

7. The pecking block of claim 1 wherein the inner core of said cement block is filled with cured AAFCO approved ingredients.

8. The block of claim 1 which includes a hanger at the suspension point.

9. The pecking block of claim 1 which includes with it, in a kit a floor litter cover, floor fasteners, and a suspension hanger.

10. The pecking block of claim 1 wherein the pecking block exterior, and inner core are both colored green.

11. The method of preventing perching on the combination pecking block of claim 1, comprising:
mounting said block in a confinement poultry structure to impose an angled surface on the block that inhibits the birds perching on it.
